(19) United States
(12) Patent Application Publication
(10) Pub. No.: US 2011/0063508 A1
(43) Pub. Date: Mar. 17, 2011

(54) INFORMATION PROCESSING APPARATUS AND ITS DISPLAY METHOD

(76) Inventor: Hayato Nishimura, Fukaya-shi (JP)

(21) Appl. No.: 12/815,099

(22) Filed: Jun. 14, 2010

(30) Foreign Application Priority Data
Sep. 15, 2009 (JP) 2009-212773

(51) Int. Cl. H04N 5/445

(52) U.S. Cl. 348/563; 348/E05.105

(57) ABSTRACT

An information processing apparatus includes: a reception module configured to receive a selection command input by a user; a connector unit configured to be connectable with an external device; a selection menu output module configured to output, to a display device, a video signal for displaying an application selection menu that enables selection from applications relating to the external device when a connection of the external device to the connector unit is detected; and a controller configured to activate an application requested by the user which is selected by the selection command input by the user through the application selection menu.

### CROSS-REFERENCE TO THE RELATED APPLICATION(S)

The present application is based upon and claims priority from prior Japanese Patent Application No. 2009-212773, filed on Sep. 15, 2009, the entire contents of which are incorporated herein by reference.

### BACKGROUND

1. Field

The present invention relates to an information processing apparatus and display method therefor having a media player function.

2. Description of the Related Art

The media player function has come to be used in electronic apparatus. The media player function is a function that allows an electronic apparatus to display, as a layer, contents of various media such as audio/video data (AV data). That is, the media player function allows an electronic apparatus to display AV data that is stored in an apparatus or device externally connected to the electronic apparatus in the same manner as AV data stored in a built-in HDD or the like.

For example, JP-A-2005-203900, which is directed to a data recording apparatus, describes a TV receiver that reproduces digital information recorded in a memory card and outputs resulting video and audio. Furthermore, electronic apparatus capable of handling plural kinds of recording media are known. However, those electronic apparatus are associated with a problem that to display a content such as a video image, a picture, or music the user is required to first recognize or become aware of a type of a subject recording medium and then select an application capable of activating the subject recording medium. This is inconvenient to the user.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a block diagram outlining a configuration of a TV receiver according to an embodiment of the present invention.

FIG. 2 shows an auto start screen for selecting an application to be activated in the embodiment.

FIG. 3 is a preview display screen for video image contents stored in an external connection device in the embodiment.

FIG. 4 is a flowchart of a selective playback process according to the embodiment.

FIG. 5 shows a selection screen of selective playback used in the embodiment.

FIG. 6 is a selective playback list screen used in the embodiment.

FIG. 7 shows various operation keys provided on a remote controller shown in FIG. 1.

### DETAILED DESCRIPTION

An embodiment according to the present invention will be described in detail with reference to the accompanying drawings. The scope of the claimed invention should not be limited to the examples illustrated in the drawings and those described below.

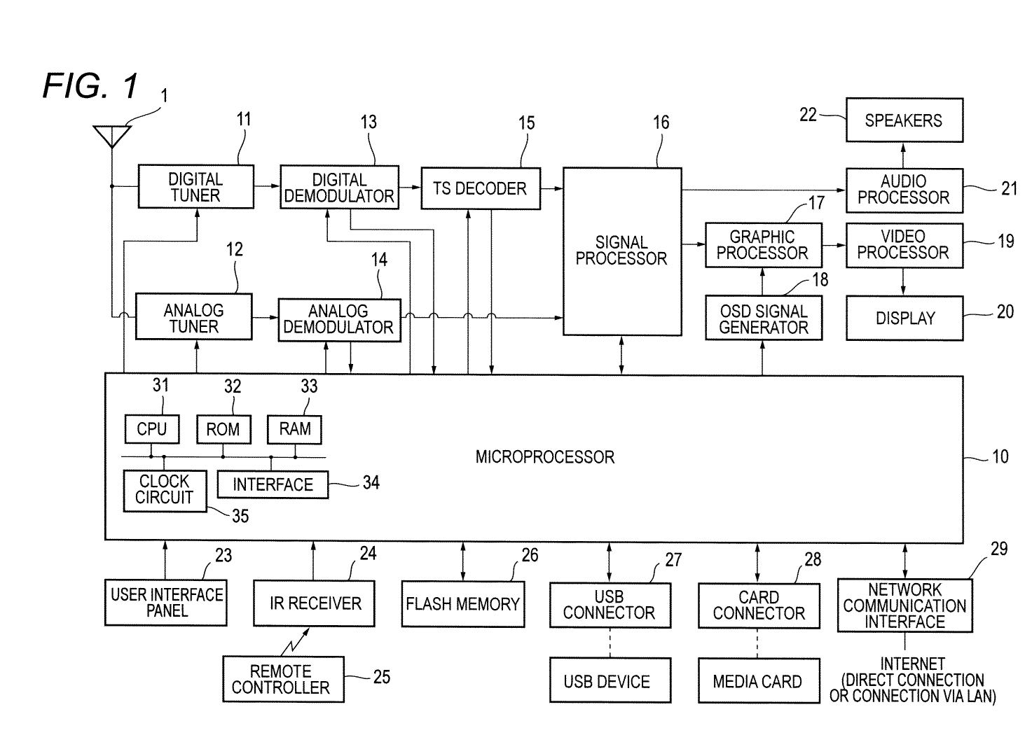

A TV receiver according to an embodiment of the present invention will be hereinafter described with reference to FIGS. 1-7.

FIG. 1 outlines the configuration of the TV receiver according to the embodiment of the invention. The TV receiver, which receives terrestrial analog broadcast waves and BS, CS, and terrestrial digital broadcast waves, is equipped with a microprocessor 10, a digital tuner 11, an analog tuner 12, a digital demodulator 13, an analog demodulator 14, and a TS decoder 15.

BS, CS, and terrestrial digital broadcast waves are received by an antenna 1 and resulting reception signals are supplied to the digital tuner 11. Likewise, terrestrial analog broadcast waves are received by the antenna 1 and resulting reception signals are supplied to the analog tuner 12. Each of the digital tuner 11 and the analog tuner 12 employs a phase-locked loop (PLL), and is used for tuning in to a desired broadcast signal by specifying reception parameters such as a center frequency and a bandwidth under the control of the microprocessor 10.

For example, in the case of the terrestrial digital broadcast in Japan, the broadcast reception signal selected by the digital tuner 11 is supplied to the digital demodulator 13 which is of an OFDM (orthogonal frequency division multiplexing) type and then to the TS decoder 15, whereby it is demodulated and decoded into a digital video signal and audio signal. The reception signal selected by the analog tuner 12 is supplied to the analog demodulator 14, where it is demodulated into an analog video signal and audio signal.

The TV receiver is also equipped with a signal processor 16, a graphic processor 17, an OSD (on-screen display) signal generator 18, a video processor 19, a display 20, an audio processor 21, speakers 22, a user interface panel 23, an IR receiver 24, a remote controller 25, a flash memory 26, a USB (universal serial bus) connector 27, a card connector 28, and a network communication interface 29. The signal processor 16 selectively performs various digital signals processing on the digital video signal and audio signal supplied form the TS decoder 15 and outputs resulting video signal and audio signal to the graphic processor 17 and the audio processor 21, respectively. Furthermore, the signal processor 16 selectively digitizes the analog video signal and audio signal supplied from the analog demodulator 14, performs given pieces of digital signal processing on resulting digital video signal and audio signal, and outputs resulting video signal and audio signal to the graphic processor 17 and the audio processor 21, respectively.

The graphic processor 17 selectively superimposes an OSD signal generated by the OSD signal generator 18 on the digital video signal that is output from the signal processor 16, and outputs a resulting video signal. The video processor 19 performs, on the digital video signal that is output from the graphic processor 17, conversions such as a size adjustment to make the digital video signal suitable for the display 20. The display 20 displays video corresponding to the video signal that is output from the video processor 19. The audio processor 21 performs, on the digital audio signal that is output from the signal processor 16, conversions such as a volume adjustment to make the digital audio signal suitable for the speakers 22. The speakers 22 reproduce audio corresponding to the audio signals that are output from the audio processor 21.

The microprocessor 10 receives operation command supplied from the user interface panel 23 or operation command transmitted from the remote controller 25 and received by the IR receiver 24, and controls individual components in such a manner that the content of the operation is reflected therein. The user interface panel (keyboard) 23 and the remote controller 25 correspond to an operation module that functions as a user interface. As shown in FIG. 1, the microprocessor 10 includes a CPU 31 which performs various kinds of processing and control, a ROM 32 which holds control programs of the CPU 31 and various initial data, a RAM 33 which provides a work area where input/output information of the CPU 31 is stored temporarily, an interface 34 for input/output of setting information and control information for each component via an I2C bus or the like, and a clock circuit 35 which is corrected according to time information and date information that are acquired from broadcast waves or over a network.

The USB connector 27 is provided for connection of various USB devices. The card connector 28 is provided for connection of various media cards. The network communication interface 29 is connected to the Internet directly or via a LAN (local area network). Where time information is to be acquired from broadcast waves, the microprocessor 10 captures it from a signal received by the antenna 1. Where basic data such as time information, weather information, and fortune-telling information are to be acquired over a network, the microprocessor 10 captures those data from the network communication interface 29.

BGM (preinstalled BGM) and various kinds of registration information to be used for reproduction of the BGM may be stored in the flash memory 26 (nonvolatile memory) in advance, that is, at the shipment stage of the TV receiver, by the manufacturer side.

Video image, picture, or musical data can be read via the USB connector 27 or the card connector 28 from an external USB device (memory or the like) or memory card that is connected to it.

To realize a photo viewer function, a photo frame function, for example, the microprocessor 10 is configured so as to be able to perform a control for capturing one or plural photo images that are held as files in a USB memory connected to the USB connector 27 or a media card connected to the card connector 28 and displaying each photo image on the display 20 after causing the signal processor 16, the graphic processor 17, and the video processor 19 to process it.

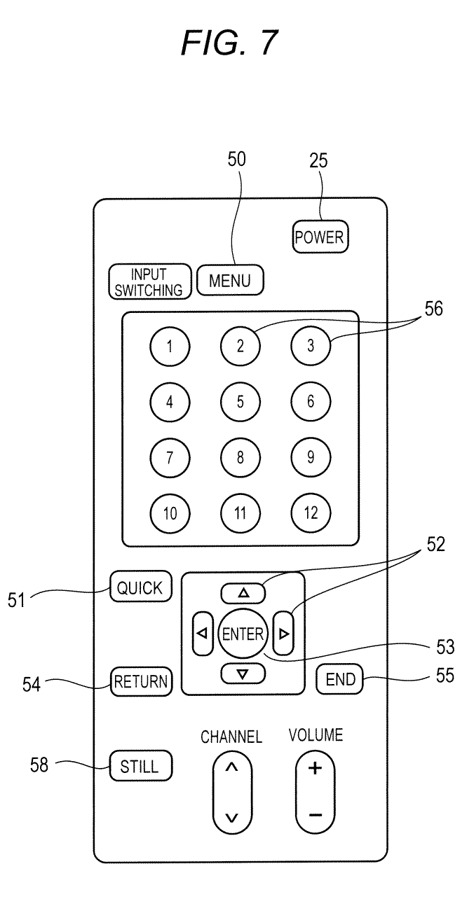

FIG. 7 shows various operation keys provided on the remote controller 25. The user causes options to be displayed on the display 20 by manipulating a main menu key 50 or a quick menu key 51, selects an option by manipulating four-direction keys 52, and decides on the selected item by manipulating an enter key 53. A return key 54 is operated to return to a preceding screen and an end key 55 is operated to finish a series of operations. A channel key 56 is operated to select a broadcast signal or cancel a photo frame display. The rightward and leftward direction keys 52 may also serve as a reverse playback key and a playback key, respectively.

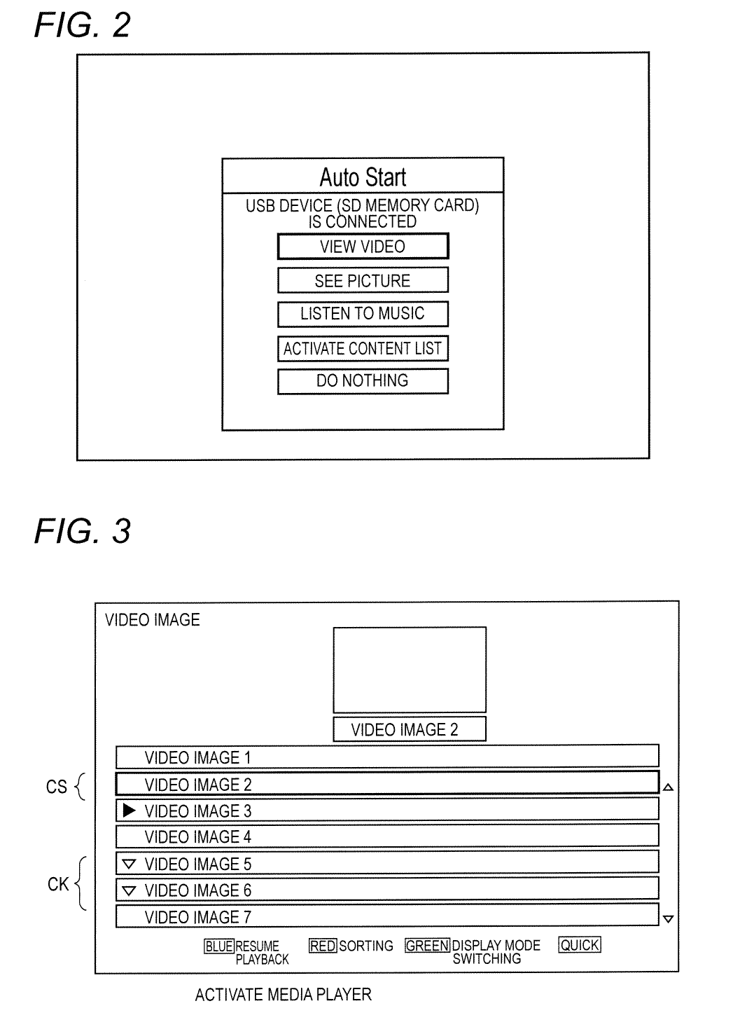

FIG. 2 shows a popup screen that is displayed by an auto start function which utilizes detection of insertion of a connection device into the USB connector 27 or the card connector 28 (hereinafter referred to as device insertion detection). The auto start function determines a type of a connected device and displays a list of applications that can be activated as applications correlated with the detected device (for the USB connector 27, a USB device such as an SD memory card or some other device; in the example of FIG. 2, an SD memory card is inserted in the USB connector 27). The auto start function is activated automatically in response to device insertion detection. When the auto start function is activated, a confirmation screen (popup screen) is presented as shown in FIG. 2. The confirmation screen serves for selection of an application (e.g., an application for activating a list of recorded contents) that enables use of the external device. In the confirmation screen of FIG. 2, the cursor (enclosing frame) is currently placed at an item “View a video image.” If the user presses the enter key 53 of the remote controller 25 in this state, activation of a media player is selected (selection is finalized) and a transition is made to a display screen shown in FIG. 3. If “See pictures” or “Listen to music” is selected, a transition is made to a display screen that is similar (there are small differences) to the one shown in FIG. 3.

The auto start function is activated automatically for an insertion-detected device and does not require the user to select a device. And no device selection screen is displayed unlike in the case of an ordinary menu that is displayed when the main menu key 50, the quick menu key 51, or the like is operated. This is an important feature of the embodiment.

FIG. 3 shows a screen for display of a list of video image contents that are stored in the external connection device. A preview video image of the content indicated by the cursor is played back in a preview area that occupies a top portion of the screen. In the example of FIG. 3, a preview of video image-2 (indicated by CS in FIG. 3) among video image-1 to video image-7 is being performed. A transition is made to this list display screen (normal list (described later)) upon selection of the item “View a video image” in the auto start confirmation screen of FIG. 2. The media player allows the user to view movies, pictures, and pieces of music that are stored in an external connection device or the built-in HDD.

The screen of FIG. 3 is a movie list screen and has, for example, the following features:
The cursor is moved in the vertical direction by the upward/downward direction keys.
A preview area is formed at a top position of the screen and a preview playback is performed there for the content indicated by the cursor.
The preview playback is started when the cursor has continued to be placed on the item, of a content for a given number of seconds.
If the enter key or the playback key is pressed, a transition is made to a full-screen playback of the content.
Even if a resume point (i.e., a position where a playback of a content was suspended) is stored, the content is played back from the head if the enter key or the playback key is pressed.
Where there exists a content for which a resume point is stored, a resume playback is performed if a blue key on the screen is pressed. A resume point is stored for one content, for example. (Whether a resume point is stored or not is indicated by an icon to be displayed in the list.)
A resume point may be canceled upon a playback of another content or continued to be stored forever.

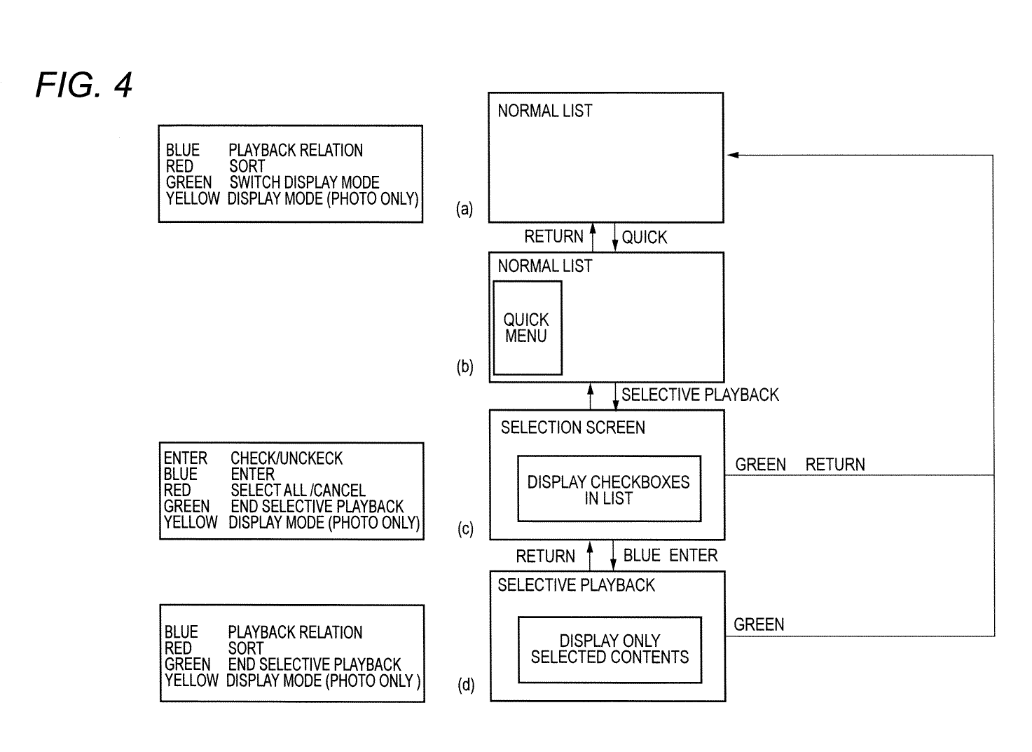

FIG. 4 is a transition flowchart showing a selective playback process according to the embodiment. Selective playback contents are selected through a quick menu that pops up in an normal list screen (a list display screen as shown in FIG. 3), and check marks (indicated by CK in FIG. 3) each indicating that the content has been selected for selective playback are displayed in a selection screen. In the selection screen, a subject content is checked or unchecked by manipulating the enter button. Then, a transition is made to a selective playback list screen when the blue key is pressed. Only the contents that were selected arbitrarily are taken out and displayed in the form of a list. The selective playback mode is finished when the green key is pressed.

Elements relating to the above transition flowchart are as follows:

<Display Mode>

Switching is made between display modes by the green key in the normal list screen. The display modes are all display and folder display.
All display: The movie contents stored in the selected device are displayed non-hierarchically, that is, displayed so as to be in a single directory without being layered in a hierarchical filing format. The screen of FIG. 3 employs the all display mode.
Folder display: The movie contents stored in the selected device are displayed in a layered manner according to a folder structure.

The folder display mode is employed in the initial state.

### <Sorting>

Sorting is performed when the red key is operated. File name order, latest-first order, oldest-first order are provided as items of the content sorting.
File name order: Contents are sorted in ascending order of file names.
Latest-first order: Contents are sorted according to the newness of their update dates.
Oldest-first order: Contents are sorted according to the oldness of their update dates.

The file name order is employed in the initial state.

<Selective Playback>

The selective playback is a manner of playback in which only selected video image contents in the same directory are played back.
A transition is made to a selection screen when an item “selective playback” in a quick menu is selected.
Checkboxes are displayed when a selection screen is activated. None of the checkboxes are checked immediately after the activation.
The display mode of a normal list that was displayed immediately before a transition to a selection screen continues to be employed after the transition (the display mode cannot be switched).
A checkbox is checked or unchecked when the enter button is pressed.
All contents are selected or selection of all contents is canceled when the red button is pressed (selection of all contents is canceled if the red button is pressed in a state that all checkboxes are checked and all contents are selected if the red button is pressed in a state that at least one checkbox is not checked).
When the blue key is pressed, the selection is finalized and a transition is made to a selective playback list.
In a selective playback list, only contents that were selected in a selection screen are taken out and displayed seamlessly (display mode switching is not made in the selective playback list).
The selective playback is finished when the green key is pressed.

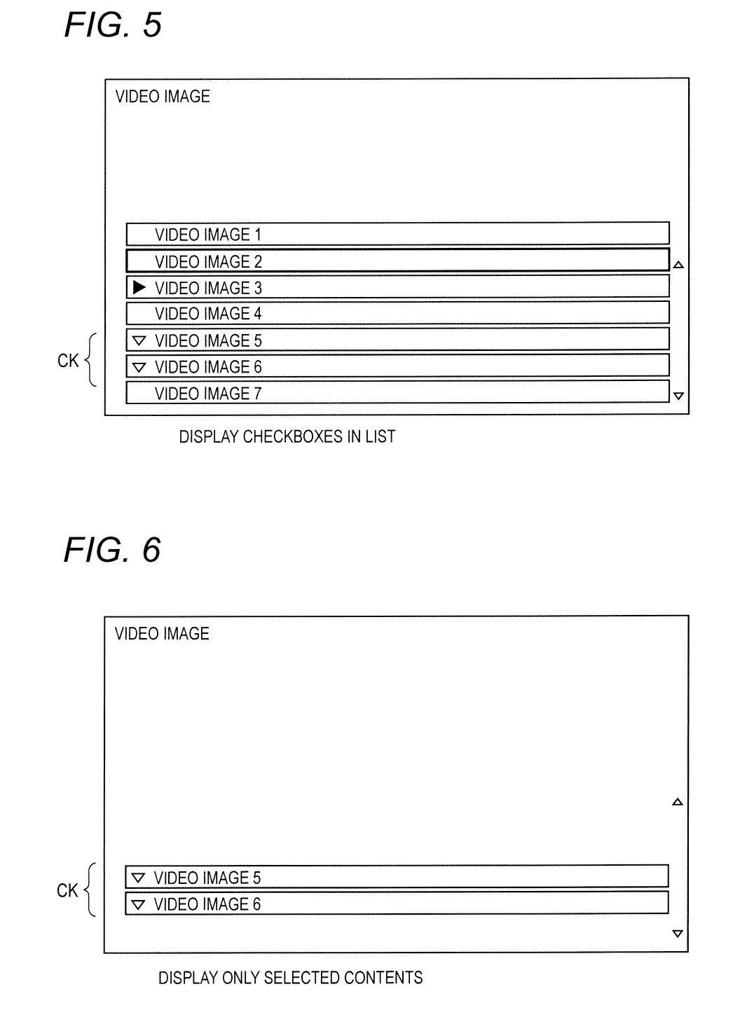

FIG. 5 shows a selection screen of the selective playback used in the embodiment and corresponds to section (c) of FIG. 4. FIG. 6 shows a selective playback list screen used in the embodiment and corresponds to section (d) of FIG. 4.

In the embodiment, the media player function of digital television is provided with the auto start function which utilizes device insertion detection and a list of applications that can be activated for a detected device is displayed. As a result, the time and labor that are taken to activate an application desired by the user can be saved.

When a list of video image contents stored in a connected device is displayed, a preview of a content indicated by the cursor is performed. As a result, the details of each content can be recognized even if it is not played back in a full screen mode. This facilitates a content search.

The media player function of the embodiment is provided with the selective playback function which enables playback of only contents that are desired by the user without the need for storing them in the TV receiver. As a result, the time and labor of storage and deletion of contents can be saved.

The embodiment has the following features:

1. The auto start function which utilizes device insertion detection is provided as a method for activating the media player function. All applications relating to an insertion-detected device are displayed in a selection screen and an application desired by the user is activated.

2. In the media player function, a preview area is provided in a screen for display of a list of video image contents stored in an external connection device and a content is preview-displayed there.

3. The media player function is provided with the selective playback function which enables playback of only contents that are desired by the user without the need for storing them in the TV receiver.

Although the embodiment according to the present invention has been described above, the present invention is not limited to the above-mentioned embodiments but can be variously modified. Constituent components disclosed in the aforementioned embodiment may be combined suitably to form various modifications. For example, some of all constituent components disclosed in the embodiment may be removed, replaced, or may be appropriately combined with other components.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a reception module configured to receive a selection command input by a user;
a connector unit configured to be connectable with an external device;
a selection menu output module configured to output, to a display device, a video signal for displaying an application selection menu that enables selection from applications relating to the external device when a connection of the external device to the connector unit is detected; and
a controller configured to activate an application requested by the user which is selected by the selection command input by the user through the application selection menu.

2. The apparatus of claim 1,
wherein the application selection menu comprises, as selection items, applications for reproducing contents stored in the external device.

3. The apparatus of claim 2, further comprising:
a content selection menu output module configured to output, to the display device, a video signal for displaying a content selection menu that enables selection from contents stored in the external device when an application for reproducing the contents stored in the external device is selected.

4. The apparatus of claim 3,
wherein the content selection menu output module is configured to output, as the video signal for displaying the content selection menu, a video signal for displaying a menu that enables selection of plural content that is requested by the user to be reproduced.

5. The apparatus of claim 1 further comprising the display device.

6. A display method comprising:
receiving a selection command input by a user;
displaying an application selection menu that enables selection from applications relating to an external device connected to a connecter when a connection of the external device to the connector unit is detected; and
activating an application requested by the user which is selected by the selection command input by the user through the application selection menu.
